(19) United States
(12) Patent Application Publication
(10) Pub. No.: US 2017/0253513 A1
(43) Pub. Date: Sep. 7, 2017

(54) METHOD AND SYSTEM FOR WASTEWATER TREATMENT USING MEMBRANE BIOREACTOR

(71) Applicant: Jiangxi JDL Environmental Protection Co., Ltd., Nanchang (CN)

(72) Inventors: Zhimin LIAO, Nanchang (CN); Tao ZHOU, Nanchang (CN)

(21) Appl. No.: 15/603,410

(22) Filed: May 23, 2017

Related U.S. Application Data
(63) Continuation-in-part of application No. PCT/CN2015/091153, filed on Sep. 30, 2015.

(30) Foreign Application Priority Data
Sep. 1, 2015 (CN) 201510556544.0

(51) Int. Cl. C02F 3/30; C02F 3/34; C02F 3/12; C02F 3/20; C02F 1/44; C02F 3/00

(52) U.S. Cl. CPC C02F 3/301; C02F 3/308; C02F 1/444; C02F 3/006; C02F 3/1273; C02F 3/201; C02F 3/307; C02F 3/341; C02F 2209/22; C02F 2101/105

(57) ABSTRACT

A method of wastewater treatment using a membrane bioreactor, including: controlling aeration to enable a dissolved oxygen concentration to be 0 to 1.5 mg/L, and keeping the integrated reaction vessel under a facultative environment. A wastewater treatment system by the membrane bioreactor without physical area division includes a reaction vessel, a membrane separation system, a water production system, and an aeration system. The membrane separation system is disposed inside the reaction vessel. The water production system communicates with the membrane separation system to pump filtrate out of the membrane separation system. The aeration system is employed to aerate the reaction vessel and the membrane separation system.

### CROSS-REFERENCE TO RELATED APPLICATIONS

This application is a continuation-in-part of International Patent Application No. PCT/CN2015/091153 with an international filing date of Sep. 30, 2015, designating the United States, now pending, and further claims foreign priority benefits to Chinese Patent Application No. 201510556544.0 filed Sep. 1, 2015. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND OF THE INVENTION

Field of the Invention

The invention relates to the field of wastewater treatment, and more particularly to a method and a system for wastewater treatment using a membrane bioreactor.

Description of the Related Art

As shown in FIG. 1, conventional biochemical methods for wastewater treatment require various dissolved oxygen environments including an anaerobic environment, an aerobic environment, and a facultative anaerobic/anoxic environment. In such methods, the pollutants (exemplified by the organic compound C₁₀H₁₉O₃N) are degraded according to the following equations:

C₁₀H₁₉O₃N+CO₂+SO₄→R—COOH+CH₄+NH₃+H₂S+H₂O
(producing odor at anaerobic stage)

C₁₀H₁₉O₃N+NO³⁻→CO₂+N₂+H₂O
(anoxic stage)

C₁₀H₁₉O₃N+O₂→CO₂+NO3−+H₂O
(aerobic stage)

NH₃+O₂→NO³⁻+H₂O
(aerobic stage)

For conventional wastewater treatment methods with or without membrane bioreactor (MBR), areas of different dissolved oxygen environments are disposed in one reaction system, as shown in FIGS. 2 and 4. That is to say that solid structures must be constructed to provide different dissolved oxygen environments for the degradation of pollutants. As a result, the wastewater treatment system is structurally complex, inefficient, difficult to control and maintain, and unstable in operation.

### SUMMARY OF THE INVENTION

In view of the above-described problems, it is one objective of the invention to provide a method and a system for wastewater treatment using a membrane bioreactor.

To achieve the above objective, in accordance with one embodiment of the invention, there is provided a method of wastewater treatment using a membrane bioreactor, the membrane bioreactor comprising a reaction vessel and an aeration system, the method comprising: controlling an aeration rate of the aeration system to enable a dissolved oxygen concentration in the reaction vessel to be larger than 0 and smaller than 1.5 mg/L, so that the reaction vessel is maintained at a facultative-organism-adapted environment. The membrane bioreactor further comprises a membrane separation system, a dissolved oxygen concentration in the membrane separation system is larger than 0 and smaller than 1.5 mg/L, and the reaction vessel excluding the membrane separation system is larger than 0 and smaller than 0.5 mg/L, and the dissolved oxygen concentration in the membrane separation system is higher than the dissolved oxygen concentration in the reaction vessel excluding the membrane separation system.

The degradation process of phosphorus in the pollutants is as follows:

Organisms+Phosphate+Facultative organisms→Microbial cells(organophosphorus)

Microbial cells(organophosphorus)+Facultative organisms→P₂H₄/PH₃

The degradation process of nitrogen in the pollutants is as follows:

½NH₄⁺(ammonia nitrogen)+½H₂O+¼O₂+facultative organisms→½N₂+H₂O

As nitrogen concentration in inlet water changes, a nitrogen degradation process in the reaction system is accompanied by short-cut nitrification and denitrification and the like reactions.

In accordance with another embodiment of the invention, there is provided a system for wastewater treatment using a membrane bioreactor, comprising: a reaction vessel, the membrane separation system, a water production system, and an aeration system. The membrane separation system is disposed in the reaction vessel. The water production system communicates with the membrane separation system for pumping a filtrate out of the membrane separation system. The aeration system is employed to aerate the reaction vessel and the membrane separation system. The aeration system is adapted to enable a dissolved oxygen concentration in the reaction vessel to be larger than 0 and smaller than 1.5 mg/L, so that the reaction vessel is maintained at a facultative-organism-adapted environment. A dissolved oxygen concentration in the membrane separation system is larger than 0 and smaller than 1.5 mg/L, and the reaction vessel excluding the membrane separation system is larger than 0 and smaller than 0.5 mg/L, and the dissolved oxygen concentration in the membrane separation system is higher than the dissolved oxygen concentration in the reaction vessel excluding the membrane separation system.

In a class of this embodiment, the membrane separation system employs a microfiltration membrane or an ultrafiltration membrane.

In a class of this embodiment, the aeration system employs microporous aeration, perforated aeration, or a combination thereof.

In a class of this embodiment, the membrane separation system is flushed by concentrating an aeration rate at the membrane separation system by the aeration system.

In a class of this embodiment, the membrane separation system is concentratedly aerated by increasing a number of holes or bore size of a perforated aeration pipe corresponding to the membrane separation system.

In a class of this embodiment, the membrane separation system is concentratedly aerated by increasing a number of microporous aeration disks corresponding to the membrane separation system.

Compared with existing technologies, advantages of the method and system of wastewater treatment using the membrane bioreactor without physical area division are as follows: the reaction vessel is maintained at a facultative-organism-adapted environment, which is easy to control and consume less dissolved oxygen. The dissolved oxygen concentration in the membrane separation system is higher for the convenience of scouring.

### BRIEF DESCRIPTION OF THE DRAWINGS

FIG. 1 is a flow chart of a conventional biochemical method of wastewater treatment;

FIG. 2 is a flow chart of a conventional wastewater treatment method using a membrane bioreactor;

FIG. 3 is a flow chart of a wastewater treatment method of the invention;

FIG. 4 is dissolved oxygen concentrations of a conventional biochemical method of wastewater treatment;

FIG. 5 is a dissolved oxygen concentration of a wastewater treatment method of the invention;

FIG. 6 is a schematic diagram of a perforated aeration pipe of a wastewater treatment system comprising a membrane bioreactor in accordance with one exemplary embodiment of the invention;

FIG. 7 is a schematic diagram of a microporous aeration structure of a wastewater treatment system comprising a membrane bioreactor in accordance with one exemplary embodiment of the invention;

FIG. 8 is a schematic diagram of a wastewater treatment system comprising a membrane bioreactor in example 1;

FIG. 9 is a schematic diagram of a wastewater treatment system comprising a membrane bioreactor in example 2; and

FIG. 10 is a schematic diagram of a wastewater treatment system comprising a membrane bioreactor in example 3.

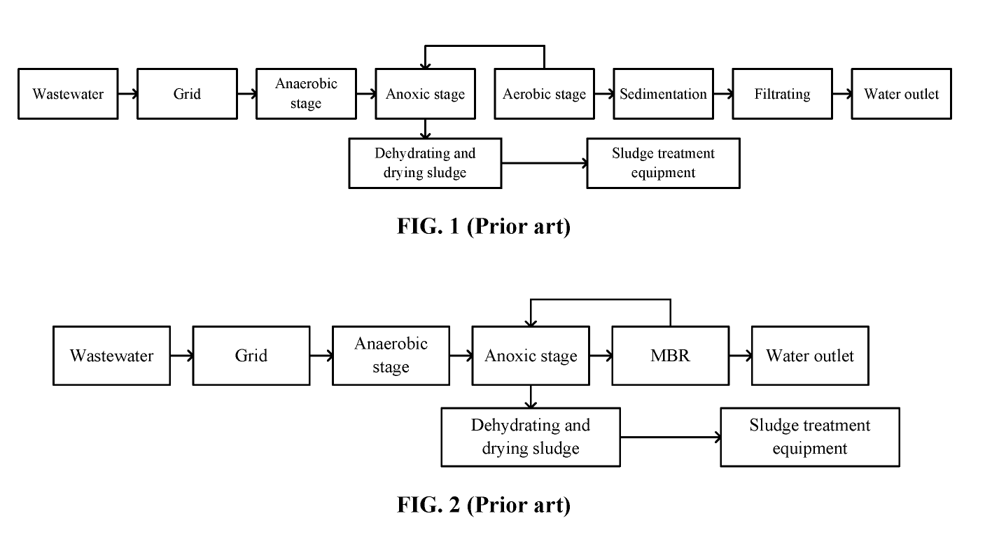

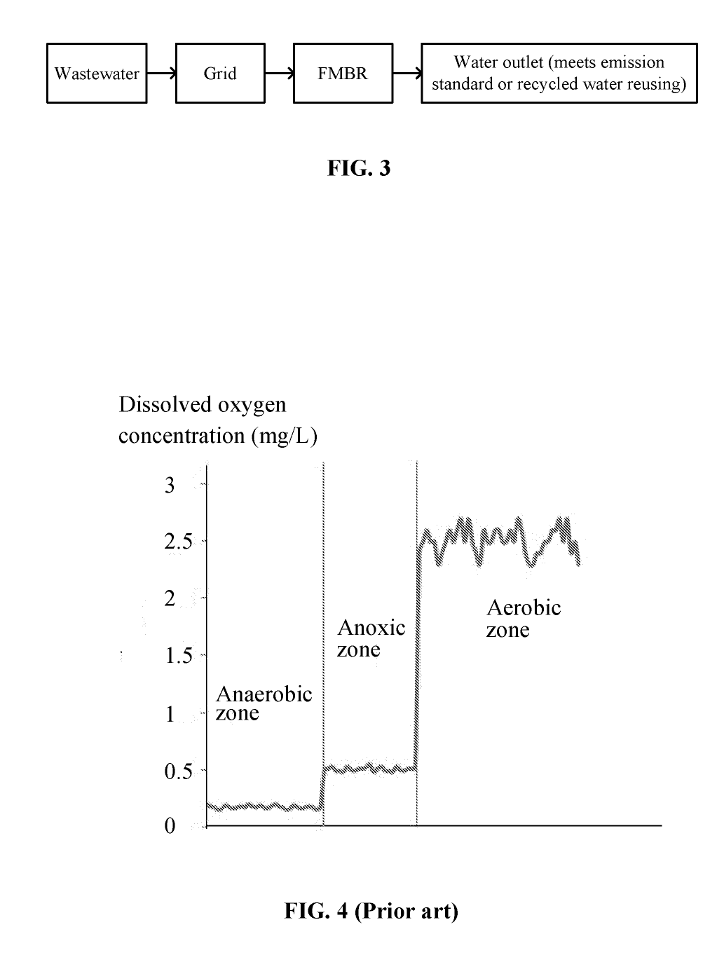

### DETAILED DESCRIPTION OF THE EMBODIMENTS

For further illustrating the invention, experiments detailing a method and a system for wastewater treatment using a membrane bioreactor are described below. It should be noted that the following examples are intended to describe and not to limit the invention.

The method of wastewater treatment using a membrane bioreactor comprising a reaction vessel and an aeration system is provided. The method comprises controlling the aeration rate of the aeration system to enable a dissolved oxygen concentration in a reaction vessel to be larger than 0 and smaller than 1.5 mg/L, so that the reaction vessel is maintained at a facultative-organism-adapted environment. Preferably, the dissolved oxygen concentration is below 1.5 mg/L in the membrane separation system, and concentrations are below 0.5 mg/L in other areas. The dissolved oxygen concentration in the membrane separation system is higher than those of other areas so as to guarantee scour intensity, and the concentration difference has no influence on the facultative environment of the reaction system. The wastewater treatment system by the membrane reactor without the area division employs a facultative membrane reactor (FMBR). A flow chart of the method of wastewater treatment by the membrane reactor without physical area division is shown as FIG. 3.

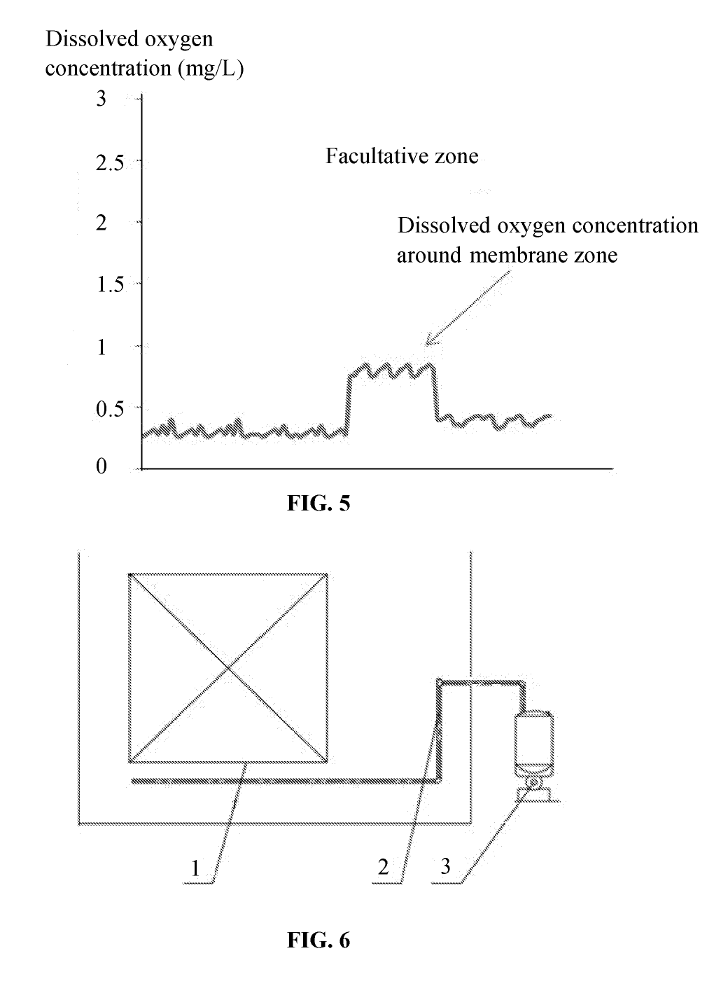

A dissolved oxygen concentration of a method of wastewater treatment by the membrane bioreactor without physical area division is shown as FIG. 5. Under a facultative environment, characteristic organisms comprise aerobic organisms, anaerobic organisms, and mostly facultative organisms, and the organisms coexist in one reaction zone. Macromolecule pollutants are degraded into micromolecule and are further gasified. Phosphorus in the pollutant is not discharged in the sludge, but is gasified and discharged in the form of phosphine or biphosphine. Nitrogen in the pollutant is not only degraded via nitrification and denitrification or short-cut nitrification and denitrification, but also is gasified and degraded via anaerobic ammonium oxidation bacteria. Dead organisms (organic residual sludge) can be utilized as the nutrient source of the living organisms and are not discharged form the reactor, thereby realizing zero discharge of organic residual sludge during the whole reaction process.

The pollutant degradation process of the method of wastewater treatment by the membrane bioreactor without physical area division is shown as follows:

Organisms+Phosphate+Facultative organisms→Microbial cells(organophosphorus)

Microbial cells(organophosphorus)+Facultative organisms→P₂H₄/PH₃

½NH₄⁺(Ammonia nitrogen)+½H₂O+¼O₂+Facultative organisms→½NO₂⁻+2e+3H⁺

½NH₄⁺(Ammonia nitrogen)+½NO₂⁻+Facultative organisms→½N₂+H₂O

### Example 1

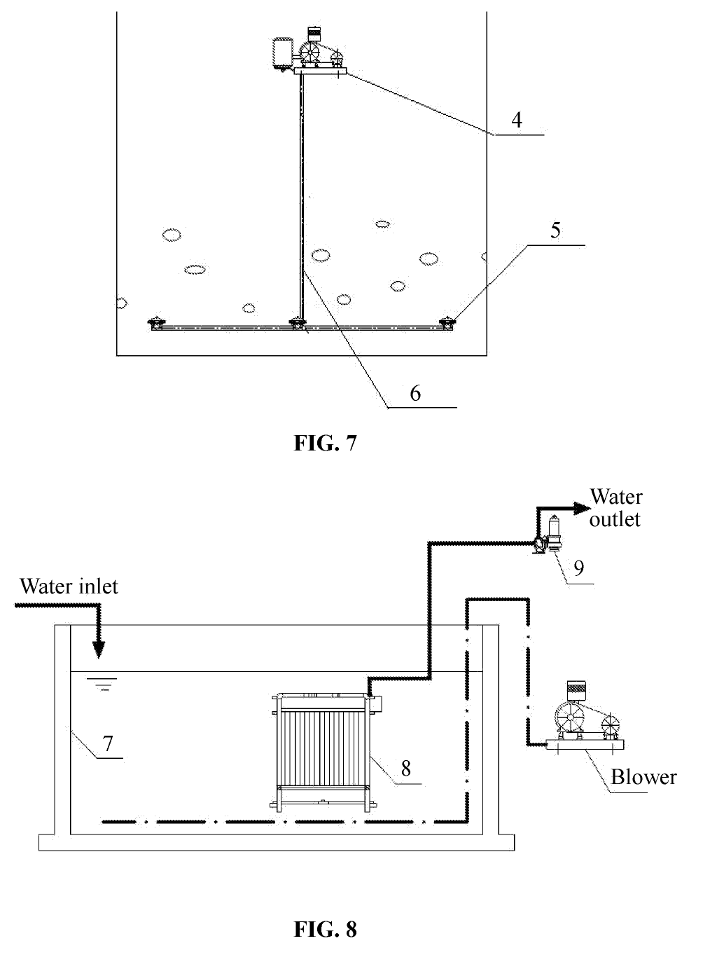

As shown in FIG. 8, a wastewater treatment system comprising a membrane bioreactor employed an integrated wastewater processor using membrane technology, comprising a reaction vessel 7, a membrane separation system, a water production system, and an aeration system. Areas in the reaction vessel 7 are not divided via separators. The membrane separation system adopted an ultrafiltration membrane assembly 8. The water production system pumped water via a water production pump 9. A blower and an aeration pipe were adopted to aerate in the aeration system. Domestic wastewater passed through the reaction vessel 7, and the blower 3 or 4 controlled aeration to offer oxygen. As shown in FIG. 6, a perforated aeration pipe 2 was employed to aerate beneath the ultrafiltration membrane assembly 1, and microporous aeration disks 5 and aeration pipes 6 and were employed to aerate at other areas as shown in FIG. 7, thereby forming a facultative reaction zone in the processor. A dissolved oxygen concentration at the membrane was controlled at 0.8-1.2 mg/L, and the dissolved oxygen concentration at other regions was controlled at 0.5-1 mg/L. The pollutants were degraded and removed via a high-efficiency degradation of high-concentration characteristic organism, and finally the pollutants were filtrated via the ultrafiltration membrane assembly disposed on the reaction zone, thereby realizing zero discharge of organic residual sludge during the whole reaction process.

### Example 2

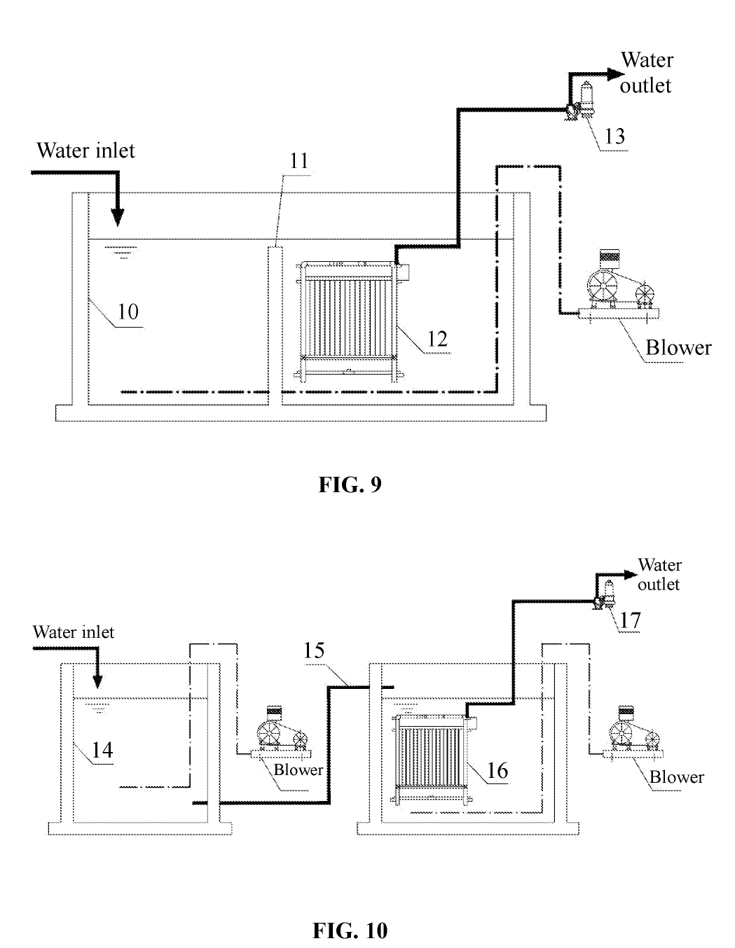

As shown in FIG. 9, a wastewater treatment system comprising a membrane bioreactor employed an integrated wastewater processor using membrane technology, comprises a reaction vessel 10, a membrane separation system, a water production system, and an aeration system. Areas in the reaction vessel 10 were divided into two, three, or more reaction zones via separators 11. The membrane separation system adopted an ultrafiltration membrane assembly 12. The water production system pumped water via a water production pump 13. A blower and an aeration pipe were adopted to aerate in the aeration system. Domestic wastewater passed through the processor, and the blower offered oxygen for the integrated reaction zone, or each reaction zone was aerated by a plurality of blowers with a similar aeration rate. As shown in FIG. 6, a perforated aeration system was employed to aerate, and the holes of a perforated pipe per unit area beneath the membrane assembly were more than those of other areas, thereby forming a facultative reaction zone in the processor. A dissolved oxygen concentration at the membrane was controlled at 0.9-1.4 mg/L, and the dissolved oxygen concentration at other regions was controlled at 0.2-0.5 mg/L. The pollutants were degraded and removed via a high-efficiency degradation of high-concentration characteristic organism, and finally the pollutants were filtrated via the ultrafiltration membrane assembly disposed on the reaction zone, thereby realizing zero discharge of organic residual sludge during the whole reaction process.

### Example 3

As shown in FIG. 10, a wastewater treatment system comprising a membrane bioreactor employed an integrated wastewater processor using membrane technology, comprising a reaction vessel, a membrane separation system, a water production system, and an aeration system. The reaction vessel employed a civil pool construction, comprising a reaction pool 14 which was a water inlet and a reaction pool 15 which was a water outlet, and the two pools were connected via a pipe. The membrane separation system employed an ultrafiltration membrane assembly 16, and the ultrafiltration membrane assembly 16 was disposed on the reaction pool 15 alone. The water production system pumped water via a water production pump 17. A blower and an aeration pipe were adopted to aerate in the aeration system. Domestic wastewater passed through the reaction system, and the blower offered oxygen for the two reaction pools, or each reaction pool was aerated by two blowers with a similar aeration. As shown in FIG. 7, a microporous aeration structure was employed to aerate, and microporous aeration disks beneath the membrane assembly were more than those of other areas, thereby forming a facultative reaction zone in the processor. A dissolved oxygen concentration at the reaction pool with the membrane assembly was controlled at 0.9-1.3 mg/L, and the dissolved oxygen concentration at other areas is controlled at 0.2-0.5 mg/L. The pollutants were degraded and removed via a high-efficiency degradation of high-concentration characteristic organism, and finally the pollutants were filtrated via the ultrafiltration membrane assembly disposed on the reaction zone, thereby realizing zero discharge of organic residual sludge during the whole reaction process.

The invention claimed is:

1. A method of wastewater treatment using a membrane bioreactor, the membrane bioreactor comprising a reaction vessel and an aeration system, the method comprising: controlling an aeration rate of the aeration system to enable a dissolved oxygen concentration in the reaction vessel to be larger than 0 and smaller than 1.5 mg/L, so that the reaction vessel is maintained at a facultative-organism-adapted environment.

2. The method of claim 1, wherein the membrane bioreactor further comprises a membrane separation system, a dissolved oxygen concentration in the membrane separation system is larger than 0 and smaller than 1.5 mg/L, and the reaction vessel excluding the membrane separation system is larger than 0 and smaller than 0.5 mg/L, and the dissolved oxygen concentration in the membrane separation system is higher than the dissolved oxygen concentration in the reaction vessel excluding the membrane separation system.

3. A wastewater treatment system comprising a membrane bioreactor, the membrane bioreactor comprising:
a reaction vessel;
a membrane separation system;
a water production system; and
an aeration system;
wherein
the membrane separation system is disposed in the reaction vessel;
the water production system communicates with the membrane separation system to pump filtrate out of the membrane separation system;
the aeration system is employed to aerate the reaction vessel and the membrane separation system;
the aeration system is adapted to enable a dissolved oxygen concentration in the reaction vessel to be larger than 0 and smaller than 1.5 mg/L, so that the reaction vessel is maintained at a facultative-organism-adapted environment.

4. The system of claim 3, wherein a dissolved oxygen concentration in the membrane separation system is larger than 0 and smaller than 1.5 mg/L, and the reaction vessel excluding the membrane separation system is larger than 0 and smaller than 0.5 mg/L, and the dissolved oxygen concentration in the membrane separation system is higher than the dissolved oxygen concentration in the reaction vessel excluding the membrane separation system.

5. The system of claim 3, wherein the membrane separation system employs a microfiltration membrane or an ultrafiltration membrane, and the aeration system employs microporous aeration, perforated aeration, or a combination thereof.

6. The system of claim 5, the membrane separation system is flushed by concentrating an aeration rate at the membrane separation system by the aeration system.

7. The system of claim 6, wherein the membrane separation system is concentratedly aerated by increasing a number of holes or bore size of a perforated aeration pipe corresponding to the membrane separation system.

8. The system of claim 6, wherein the membrane separation system is concentratedly aerated by increasing a number of microporous aeration disks corresponding to the membrane separation system.
